(19) United States
(12) Patent Application Publication
(10) Pub. No.: US 2009/0119752 A1
(43) Pub. Date: May 7, 2009

(54) Method and system for transparent encryption and authentication of file data protocols over internet protocol

(75) Inventors: Ganesan Chandrashekhar, San Jose, CA (US); Sanjay Sawhney, Cupertino, CA (US); Hemant Puri, Santa Clara, CA (US); Aseem Vaid, San Jose, CA (US); Dharmesh Shah, San Jose, CA (US)

Correspondence Address: FISH & RICHARDSON P.C., PO BOX 1022, MINNEAPOLIS, MN, 55440-1022, US

(73) Assignee: NeoScale Systems, Inc., Milpitas, CA (US)

(21) Appl. No.: 11/947,623

(22) Filed: Nov. 29, 2007

Related U.S. Application Data
(63) Continuation of application No. 10/688,204, filed on Oct. 17, 2003, now abandoned.
(60) Provisional application No. 60/419,654, filed on Oct. 18, 2002.

(51) Int. Cl. H04L 9/00

(52) U.S. Cl. 726/4

(57) ABSTRACT

A method processing one or more files using a security application. The method includes a method processing one or more files using a security application. The method includes connecting the client to a proxy server, which is coupled to one or more NAS servers. The method includes requesting for a file from a client to the proxy server and authenticating a requesting user of the client. The method also includes authorizing the requesting user for the file requested; requesting for the file from the one or more NAS servers after authenticating and authorizing; and requesting for the file from the one or more storage elements. The file is transferred from the one or more storage elements through the NAS server to the proxy server. The method determines header information on the file at the proxy server and identifies a policy based upon the header information at the proxy server. The method also includes processing (e.g., decompressing the file, decrypting the file, and verifying the file) the file according to the policy. The method includes transferring the processed file to the user of the client.

### CROSS REFERENCES TO RELATED APPLICATIONS

This application claims priority to U.S. patent application Ser. No. 10/688,204 filed Oct. 17, 2003, which claims priority to U.S. Provisional Application No. 60/419,654 filed Oct. 18, 2002, hereby incorporated by reference for all purposes.

### BACKGROUND OF THE INVENTION

The present invention relates generally to encryption and authentication, and more specifically, to a method and system for the transparent encryption and authentication of file data in networked storage environments. Merely by way of example, the invention has been applied to a storage area network. But it would be recognized that the invention has a much broader range of applicability.

Encryption techniques are known. Certain conventional encryption techniques include Transparent Cryptographic File System, commonly called TCFS, and those known as Encrypted File System by Microsoft Corporation of Redmond, Wash., and Veritas Netbackup software by Veritas Software Corporation. Although these techniques have had some success, there are still many limitations. Specific limitations about each of these products are provided throughout the present specification and more particularly below.

Veritas backup encryption option is embedded in Veritas Netbackup software. It often requires new software to be installed on each client and also requires CPU intensive functions such as encryption to be performed on each Netbackup client. Further, this option leaves encryption keys on the clients, making the whole process not very secure. Accordingly, Veritas Netbackup software has limitations.

Microsoft EFS (Encrypted File System) has many benefits. It works well with Windows™ software based clients by Microsoft Corporation. Unfortunately, it only works for Windows clients and is basically an extension of the Windows NT/2000 Filesystem developed by Microsoft Corporation. It often requires CPU intensive functions such as encryption to be performed on each Windows client using EFS. Accordingly, EFS is limited.

TCFS is another example of an encryption tool, which has an encryption technique. It often works only for NFS (Network File Systems by Sun Microsystems, Inc. of Santa Clara, Calif.) clients, which makes TCFS limited. It also requires CPU intensive functions such as encryption to be performed on each NFS client. Although TCFS has had some success, it still has many limitations.

There is, therefore, a need for a system and method that provides encryption services transparent of the application, operating system and file system.

### BRIEF SUMMARY OF THE INVENTION

According to the present invention, techniques for encryption and authentication are provided. More specifically, the invention provides a method and system for the transparent encryption and authentication of file data in networked storage environments. Merely by way of example, the invention has been applied to a storage area network. But it would be recognized that the invention has a much broader range of applicability.

In a specific embodiment, the invention provides a method processing one or more files using a security application. The method includes a method processing one or more files using a security application. The method includes connecting the client to a proxy server, which is coupled to one or more NAS (i.e., network attached storage) servers. The method includes requesting for a file from a client to the proxy server and authenticating a requesting user of the client. The method also includes authorizing the requesting user for the file requested; requesting for the file from the one or more NAS servers after authenticating and authorizing; and requesting for the file from the one or more storage elements. The file is transferred from the one or more storage elements through the NAS server to the proxy server. The method determines header information on the file at the proxy server and identifies a policy based upon the header information at the proxy server. The header information comprises elements such as, but not limited to, a time stamp, Encrypted Data Encrypted Key and Encrypted Data Hash MAC key (encrypted with Policy Key Encryption Key), File attributes (e.g., owner-id, access-permissions, access times, policy identifier etc.). The Header is hashed using the Policy Hash MAC key in certain embodiments. The method also includes processing (e.g., decompressing the file, decrypting (e.g., NIST, AES-128, AES-192, AES-256, Triple-DES) the file, and verifying the file) the file according to the policy. The method includes transferring the processed file to the user of the client.

In an alternative specific embodiment, the invention provides a system for providing security on a network attached storage. A directed proxy server is coupled to a databus, which is coupled to a plurality of clients. The directed proxy server is adapted to add header information and to add trailer information on a file by file basis. The directed proxy server is adapted to provide policy information on either or both the header information and the trailer information. A NAS server is coupled to the directed proxy server. One or more storage devices is coupled to the filer.

In yet an alternative specific embodiment, the invention provides a method processing one or more files using a security application. The method includes connecting a security device to a NAS server, which is coupled to one or more storage elements. The method also includes detecting one or more changed files on the NAS server; detecting one or more portions of the one or more files that have been changed; and determining a policy information for at least one of the changed files to determine a security attribute information. The method includes generating header information for the changed file; attaching the header information on the changed file; and processing at least one portion of the changed file according to the policy information. The processing includes compressing the portion; encrypting the portion; and generating one or more message authentication codes associated with the portion of the changed file. The method includes transferring the changed file to one or more of the storage elements.

Still further, the present invention provides method processing one or more files using a security application. The method includes connecting the client to proxy server, which is coupled to one or more NAS servers. The method includes transferring a file from a client to the proxy server and authenticating a user of the client. The method includes authorizing the user for the file requested; processing the file using a keyed message authentication integrity process (which may have a key size of at least 128 bits or less or larger); and generating header information for the file. Header information is attached on the file. The method includes transferring the file to one or more of the NAS servers and transferring the file from the one or more NAS servers to one or more storage elements.

Still further, the invention provides an alternative method processing one or more files using a security application. The method includes connecting the client to server, which is coupled to one or more storage elements. The method also includes transferring a file from a client to the server; authenticating a user of the client; and authorizing the user for the file requested. The method includes processing the file using a keyed message authentication integrity process and generating header information for the file. The header information is attached on the file. The method also transfers the file to one or more of the storage elements.

Numerous benefits exist with the present invention over conventional techniques. In a specific embodiment, the invention provides a way to secure data stored at a NAS server irrespective of the native format that the data was originally stored in. Most other techniques are intrusive requiring changes to either native data format (as in EFS) or changes to client system (as in TCFS). This invention achieves high security, strong integrity, compression capability, file tamper detection and strong time based archival capabilities at high data rates.

The invention can also be implemented using conventional software and hardware technologies. Preferably, the invention provides suitable software and hardware features to process services at wirespeed, e.g., 1 Gigabit per second and greater. Depending upon the embodiment, one or more of these benefits or features can be achieved. These and other benefits are described throughout the present specification and more particularly below.

The accompanying drawings, which are incorporated in and form part of the specification, illustrate embodiments of the invention and, together with the description, serves to explain the principles of the invention.

### BRIEF DESCRIPTION OF THE DRAWINGS

FIG. 1 illustrates a primary storage deployment according to an embodiment of the present invention.

FIG. 2 illustrates a secondary storage deployment according to an embodiment of the present invention.

FIG. 3 is a diagram illustrating hardware assisted data path according to an embodiment of the present invention.

FIGS. 4 through 6 illustrate network systems according to embodiments of the present invention.

FIGS. 7 through 11 are simplified flow diagrams of methods according to embodiments of the present invention.

### DETAILED DESCRIPTION OF THE INVENTION

According to the present invention, techniques for encryption and authentication are provided. More specifically, the invention provides a method and system for the transparent encryption and authentication of file data in networked storage environments. Merely by way of example, the invention has been applied to a storage area network. But it would be recognized that the invention has a much broader range of applicability.

A system and method for transparently securing file data protocols over Internet Protocol (IP) are disclosed herein. The system and method provide transparent encryption, integrity, and compression for files (or other file related datasets) in primary, nearline or secondary storage environments. The system may be used, for example, to backup and restore applications, in primary storage environments, and nearline storage environments which provide a high-performance staging area for backup applications. The invention is delivered as a hardened security appliance which transparently intercepts file protocol control and data streams (either as a directed or transparent proxy) and applies security policies to datasets which are being transferred. The invention uses deep inspection of the file protocols to perform on-the-fly crypto operations on the data using keys which are securely stored in NVRAM (Non-Volatile Random Access Memory) of the tamper-proof appliance. The invention may use, for example, hardware based TCP off-load processing and off the shelf crypto chips to provide strong performance.

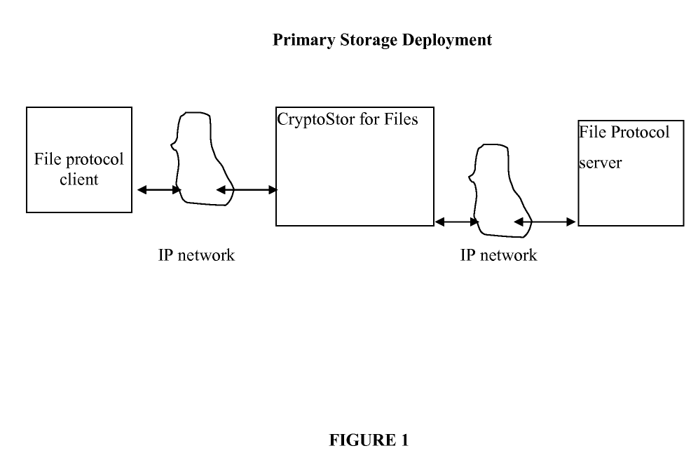

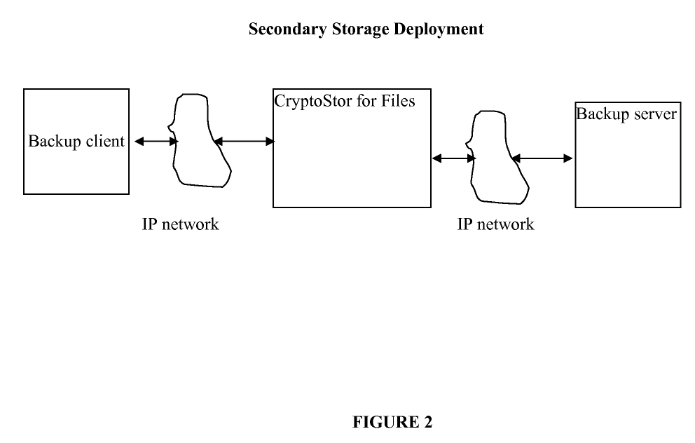

Embodiments of the present invention may include one or more of the following features:
a) Policy-based application of security to files and file related datasets;
b) Confidentiality of file data through encryption;
c) File data integrity by adding a MAC (Message Authentication Code);
d) Policy based file level access control;
e) Compression of file data prior to encryption;
f) Recovery of data thru software in the absence of the appliance;
g) Deployed in primary as well as secondary storage configurations (see FIGS. 1 and 2);
h) Provide high performance without impacting the CPU of the hosts on which the file system clients are being run;
i) Provide security services (e.g., encryption, decryption, authentication, integrity, compliance, intrusion, promotion) in a transparent manner without any modifications to backup and restore applications;
j) Provide scalable processing in an in-band media security appliance using a TCP off-load engine;
k) Provide key management which does not leave the keys on the local disk of the clients;
l) Provide these security services with high-availability and failover mechanisms.

A system of the present invention (referred to herein as ‘CryptoStor for Files’ or ‘appliance’) acts as a proxy for the file protocol server(s). The file system protocol clients are either configured to point to the CryptoStor for Files box or the CryptoStor for Files transparently intercepts file protocol requests. The intercepted control and data streams from the client are serviced by the system which examines each protocol message and uses the configured policies to determine the appropriate security policies that are applied to the message. The appliance may intercept, for example, Novell NCP, NFS and CIFS protocols.

The system acts as a proxy for the backup server(s). Protocols processed include NDMP, Veritas Netbackup, Veritas Backup Exec, Legato's Networker, CIFS, NFS, Novell NCP, and other IP protocols used for backup/restore. The appliance functions for both client as well as server initiated backups, and full as well as incremental backups of files, directories, partitions, etc.

In both environments, the system transparently stores some meta-data along with the file data or file attributes. The meta-data relates to key management, length of the original file/dataset, whether the file was compressed prior to encryption or not, integrity checks for file data. The meta-data is stripped off before the file data/file attributes are returned to the client. The system proxies the authentication function, if authentication is enabled on the client. The system can also detect whether client side compression is enabled (in backup/restore environments), and therefore selectively apply compression.

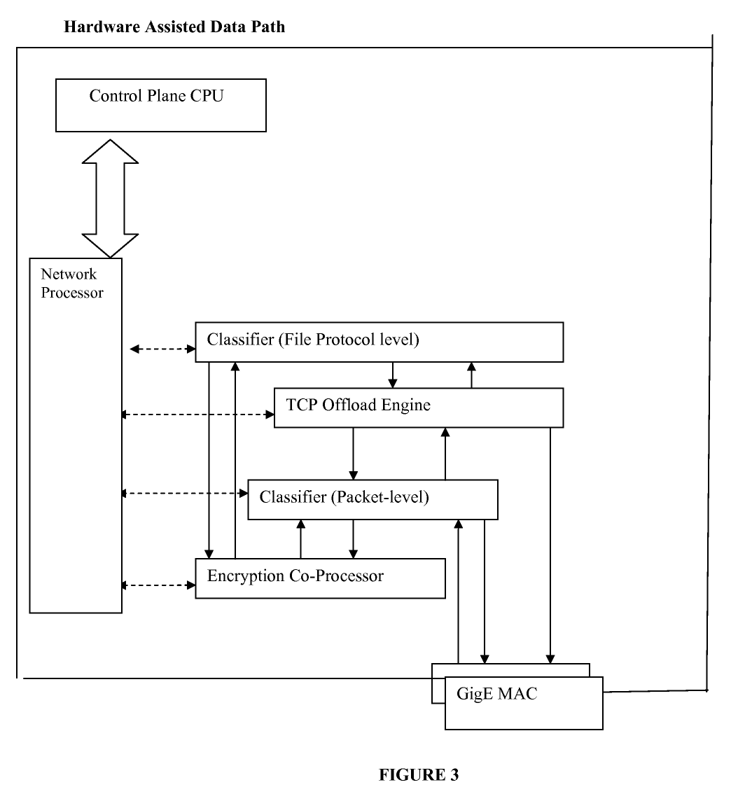

Referring to FIG. 3, the appliance includes a high-performance hardware assisted data path, and a Policy and Key Database that drives the hardware engine. The Policy Database holds all the Media rules. Media rules are defined as:
Target description->Action-to-be-taken description, Re-keying action description
   Where:
   Target Description includes:
   Server identification (and or)
   User/Group identification (and or)
   Volume identification (and or)
   Directory name (and or)
   File name; and
   Action-to-be-taken indicates:
   Access Control: deny|encrypt|passthru, where encrypt further contains:
      Encryption algo/Integrity algo/Encryption key/entropy params/Integrity Key

In one embodiment, encryption is done using symmetric algorithms with strong keys, for example, 3DES or AES with 128 bit keys. Keyed SHA-1 or Keyed MD-5 are preferred Integrity check algo. By default, all actions are encrypt.

Re-keying policy indicates interval when new keys are generated and data re-encrypted with new key. This may be different for different volumes/directories depending on volatility and criticality of data in that directory.

The Key Database holds the actual Key values. Keys are not stored in the clear. Instead they are stored under the envelope of a SuperKey which is escrowed. The system supports smart card interface to store the Keys securely. Further details of systems and methods according to embodiments of the present invention can be found throughout the present specification and more particularly below.

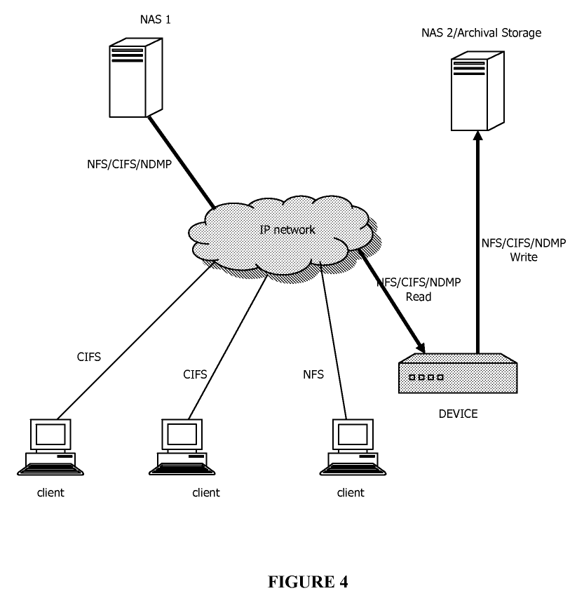

FIGS. 4 through 6 illustrate simplified diagrams 400, 500, 600 of network systems according to embodiments of the present invention. These diagrams are merely examples, which should not unduly limit the scope of the claims herein. One of ordinary skill in the art would recognize many variations, modifications, and alternatives. As shown, system 400 includes a plurality of client device 405, which are coupled to an IP network 403. A plurality of servers (i.e., NAS) 407 are also included. A security device 401 is also coupled to the network. The security device includes certain hardware and software elements that are used to carryout the methods and systems described herein. Further details of such a security device is provided in U.S. patent application Ser. No. ______ (Attorney Docket No. 021970-000510US), commonly assigned, and hereby incorporated for all purposes. Certain methods can be performed via client devices through the security device. Such methods are preferably transparent to users of the client device. Storage devices (i.e., NAS) can be conventional and include any type of network storage elements.

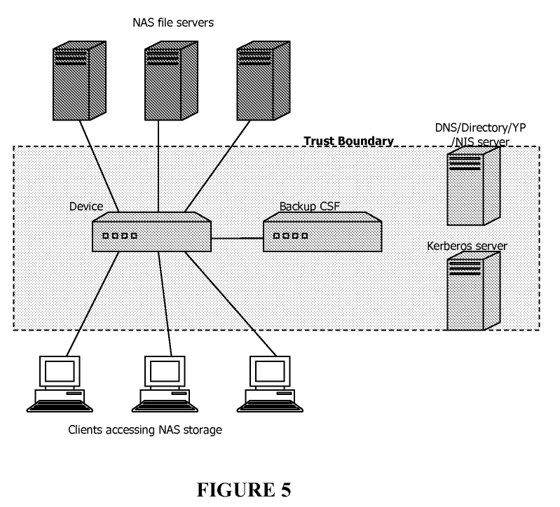

Referring to FIG. 5, system 500 also includes client devices coupled to network storage devices. The client devices are also coupled to security device, which includes a backup device. Here, the security device can act as a proxy in certain embodiments, but can also perform a variety of other features. The proxy device is secure and allows each client to use files in the NAS servers in a secure manner.

Preferably, the above system is for providing security on a network attached storage. A directed proxy server is coupled to a databus, which is coupled to a plurality of clients. The directed proxy server is adapted to add header information and to add trailer information on a file by file basis. The header information comprises elements such as, but not limited to, a time stamp, Encrypted Data Encrypted Key and Encrypted Data Hash MAC key (encrypted with Policy Key Encryption Key), File attributes (e.g., owner-id, access-permissions, access times, policy identifier etc.). The Header is hashed using the Policy Hash MAC key in certain embodiments. The directed proxy server is adapted to provide policy information on either or both the header information and the trailer information. A NAS server is coupled to the directed proxy server. One or more storage devices is coupled to the filer. Depending upon the embodiment, there can be other variations, alternatives, and modifications.

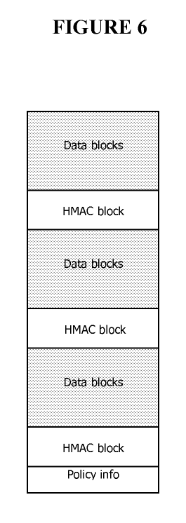

An example of data according to the present invention can be found in FIG. 6. As shown, data 600 includes data block, H (Hash) MAC bloc, data block, HMAC block, data block, HMAC block, and policy information. Depending upon the embodiment, various methods can be performed using the present system. Such methods are described throughout the present specification and more particularly below.

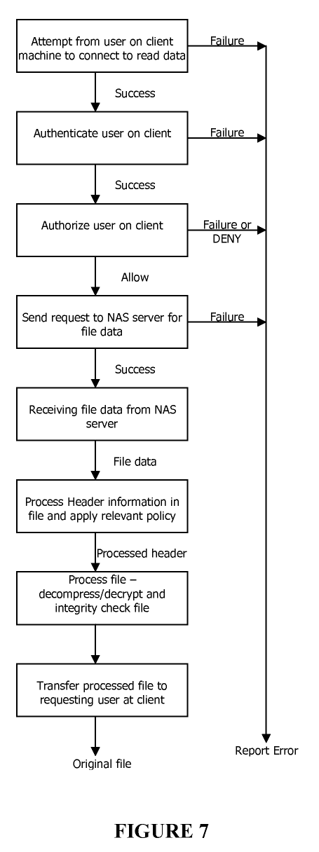

FIGS. 7 through 11 are simplified flow diagrams of methods 700, 800, 900, 1000, 1100 according to embodiments of the present invention. These diagrams are merely examples, which should not unduly limit the scope of the claims herein. One of ordinary skill in the art would recognize many variations, alternatives, and modifications. Various methods can be provided below.

A method processing one or more files using a security application according to an embodiment of the present invention may be outlined as follows:

1. Attempt to connect the client to a proxy server, which is coupled to one or more NAS servers;

2. Connect the client to the proxy server;

3. Requesting for a file from a client to the proxy server;

4. Authenticate a requesting user of the client;

5. Authorize the requesting user for the file requested;

6. Request for the file from the one or more NAS servers after authenticating and authorizing;

7. Request for the file from the one or more storage elements;

8. Transfer the file from the one or more storage elements through the NAS server to the proxy server;

9. Determine header information on the file at the proxy server;

10. Identify a policy based upon the header information at the proxy server;

11. Process (e.g., decompress, decrypt, encrypt, verify) the file according to the policy; and

12. Transfer the processed file to the user of the client.

As shown, the above sequence of steps provides a method according to an embodiment of the present invention. Such method can be used to process network data information using a variety of processes, e.g., encrypt, decompress, verify, decrypt. Depending upon the embodiment, certain steps can be combined or further separated. Certain steps may be reordered and/or other steps may be added. Of course, one of ordinary skill in the art would recognize many variations, modifications, and alternatives. A specific illustration of the present method can be illustrated by way of one or more of the Figures below, see FIG. 7 for example.

A method processing one or more files using a security application according to an embodiment of the present invention may be provided as follows:

1. Connect a security device to a NAS server, which is coupled to one or more storage elements;

2. Detect one or more changed files on the NAS server;

3. Detect one or more portions of the one or more files that have been changed;

4. Determine a policy information for at least one of the changed files to determine a security attribute information;

5. Generate header information for the changed file;

6. Attach the header information on the changed file;

7. Process (e.g., compress, encrypt) at least one portion of the changed file according to the policy information;

8. Generate one or more message authentication codes associated with the portion of the changed file;

9. Transfer the changed file to one or more of the storage elements; and

10. Perform other steps, as desired.

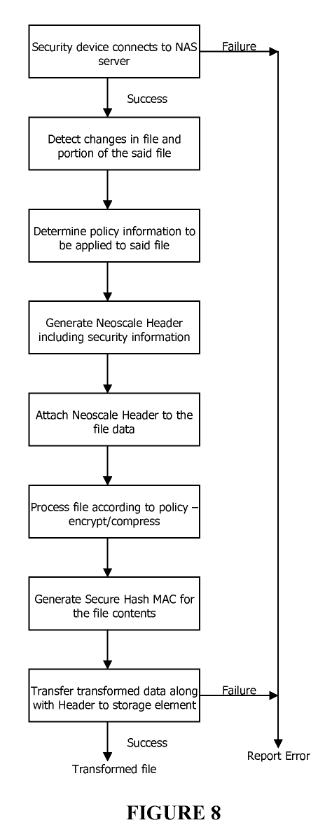

As shown, the above sequence of steps provides a method according to an embodiment of the present invention. Such method can be used to process network data information using a variety of processes, e.g., encrypt, decompress, verify, decrypt. Depending upon the embodiment, certain steps can be combined or further separated. Certain steps may be reordered and/or other steps may be added. Of course, one of ordinary skill in the art would recognize many variations, modifications, and alternatives. A specific illustration of the present method can be illustrated by way of one or more of the Figures below, see FIG. 8 for example.

A method processing one or more files using a security application according to an embodiment of the present invention may be outlined as follows:

1. Connect a client to server, which is coupled to one or more storage elements;

2. Transfer a file from a client to the server;

3. Authenticate a user of the client;

4. Authorize the user for the file requested;

5. Process the file using a keyed message authentication integrity process (e.g., SHA-1, MD-5, SHA-512;

6. Generate header information for the file;

7. Attach the header information on the file;

8. Transfer the file to one or more of the storage elements; and

9. Perform other steps, as desired.

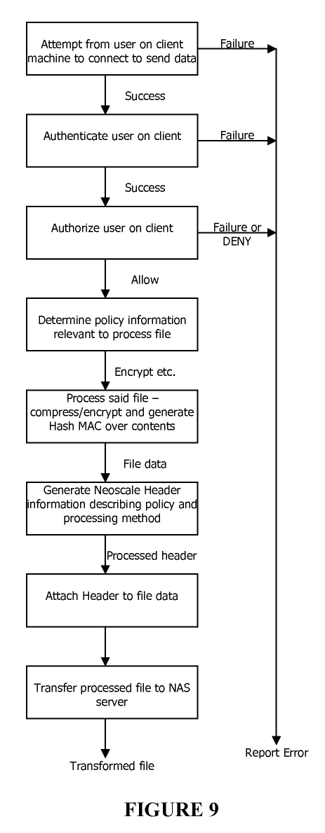

As shown, the above sequence of steps provides a method according to an embodiment of the present invention. Such method can be used to process network data information using a variety of processes. Depending upon the embodiment, certain steps can be combined or further separated. Certain steps may be reordered and/or other steps may be added. Of course, one of ordinary skill in the art would recognize many variations, modifications, and alternatives. A specific illustration of the present method can be illustrated by way of one or more of the Figures below, see FIG. 9 for example.

A method for providing secured storage of data according to an embodiment of the present invention may be identified below.

1. Provide a key encryption key;

2. Store the key encryption key on a system;

3. Store a message authentication code generating key on the system;

4. Decrypt a file encryption key with the key encryption key;

5. Decrypt a file message authentication code generating key with the key encryption key;

6. Use the file encryption key to decrypt data stored on a server or encrypt data originated by a user on a client;

7. Generate a message authentication code for a header of the file with the message authentication code generating key;

8. Use the file message authentication code generating key to generate one or more message authentication codes block by block in the file; and

9. Perform other steps, as desired.

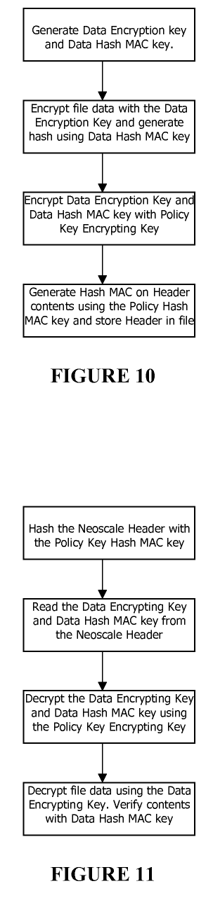

As shown, the above sequence of steps provides a method according to an embodiment of the present invention. Such method can be used to process network data information using a variety of processes. Depending upon the embodiment, certain steps can be combined or further separated. Certain steps may be reordered and/or other steps may be added. Of course, one of ordinary skill in the art would recognize many variations, modifications, and alternatives. A specific illustration of the present method can be illustrated by way of one or more of the Figures below, see FIGS. 10 and 11 for example.

Although the present invention has been described in accordance with the embodiments shown, one of ordinary skill in the art will readily recognize that there could be variations made to the embodiments without departing from the scope of the present invention. Accordingly, it is intended that all matter contained in the above description and shown in the accompanying drawings shall be interpreted as illustrative and not in a limiting sense.

What is claimed is:

1. A method processing one or more files using a security application, the method comprising:
connecting the client to a proxy server, the proxy server being coupled to one or more NAS servers;
requesting for a file from a client to the proxy server;
authenticating a requesting user of the client;
authorizing the requesting user for the file requested;
requesting for the file from the one or more NAS servers after authenticating and authorizing;
requesting for the file from the one or more storage elements;
transferring the file from the one or more storage elements through the NAS server to the proxy server;
determining header information on the file at the proxy server;
identifying a policy based upon the header information at the proxy server;
processing the file according to the policy, the processing including decompressing the file, decrypting the file, and verifying the file; and
transferring the processed file to the user of the client.

2. The method of claim 1 wherein the file comprises retrieval and verification information.

3. The method of claim 1 wherein the decryption is provided by a NIST approved process.

4. The method of claim 1 wherein the NIST approved process is selected from AES and Triple-DES.

5. The method of claim 1 wherein the verifying comprises processing a keyed message authentication code.

6. The method of claim 5 wherein the keyed message authentication code is generated using a SHA-1 or MD-5 or SHA-512.

7. The method of claim 1 further comprising determining one or more statistics in a database on a security device.

8. The method of claim 7 wherein the database is a secure catalog database.

9. The method of claim 8 further comprising using the secure catalog database to detect an intrusion.

10. The method of claim 1 further comprising adding information associated to positional integrity to the file.

11. The method of claim 1 further comprising generating a signature record on the file to detect any modification of the file.

12. The method of claim 1 further comprising identifying a number of blocks stored within a database, the database including the file.

13. A system for providing security on a network attached storage, the system comprising:
a directed proxy server coupled to a databus, the databus being coupled to a plurality of clients, the directed proxy server being adapted to add header information and to add trailer information on a file by file basis, the directed proxy server being adapted to provide policy information on either or both the header information and the trailer information;
a NAS server coupled to the directed proxy server; and
one or more storage device coupled to the filer.

14. The system of claim 13 wherein the directed proxy server communicates to the filer using an access protocol selected from NFS or CIFS format.

15. The system of claim 13 wherein the directed proxy sever is transparent to a user.

16. The system of claim 13 wherein the NAS server is transparent to the plurality of clients.

17. The system of claim 13 wherein the directed proxy server operates at a wire speed to add header information and trailer information.

18. The system of claim 13 wherein the directed proxy server is adapted to maintain a plurality of security keys, one or more of the keys is associated with a group of the files.

19. The system of claim 13 wherein the directed proxy server is adapted to maintain a plurality of security keys, one or more of the keys is associated with a user.

20. The system of claim 13 wherein the policy information is associated with a service, the service is selected from an encryption process, a decryption process, an authentication process, an integrity process, a compliance process, an intrusion detection process, or a promotion process.

21. A method processing one or more files using a security application, the method comprising:
connecting a security device to a NAS server, the NAS server being coupled to one or more storage elements;
detecting one or more changed files on the NAS server;
detecting one or more portions of the one or more files that have been changed;
determining a policy information for at least one of the changed files to determine a security attribute information;
generating header information for the changed file;
attaching the header information on the changed file;
processing at least one portion of the changed file according to the policy information, the processing including:
compressing the portion;
encrypting the portion;
generating one or more message authentication codes associated with the portion of the changed file;
transferring the changed file to one or more of the storage elements.

22. The method of claim 21 wherein the processing is provided at wire speed.

23. The method of claim 21 wherein the one or more of the storage elements is a storage area network.

24. The method of claim 21 wherein the transferring of the changed file is provided via SCSI interface.

25. The method of claim 21 wherein the policy information is provided in a library.

26. The method of claim 21 wherein the encrypting is decrypting.

27. A method processing one or more files using a security application, the method comprising:
connecting the client to proxy server, the proxy server being coupled to one or more NAS servers;
transferring a file from a client to the proxy server;
authenticating a user of the client;
authorizing the user for the file requested;
processing the file using a keyed message authentication integrity process;
generating header information for the file;
attaching the header information on the file;
transferring the file to one or more of the NAS servers;
transferring the file from the one or more NAS servers to one or more storage elements.

28. The method of claim 27 further comprising encrypting the file using a key size of at least 128 bits to form an encrypted file.

29. The method of claim 28 wherein the encrypting is provided using a NIST approved process.

30. The method of claim 28 wherein the encrypting is provided using AES-128, AES-192, AES-256, Triple-DES.

31. The method of claim 27 wherein the keyed message authentication integrity process is provided by SHA-1, SHA-2, MD-5.

32. The method of claim 27 wherein the processing is provided at wirespeed, the wirespeed being greater than 1 Gigabit/second.

33. The method of claim 27 wherein the authenticating, authorizing, processing, generating, and attaching are provided at the proxy server.

34. The method of claim 27 wherein the header information comprises at least one element selected from a time stamp, Encrypted Data Encrypted Key, Encrypted Data Hash MAC key, and File attributes.

35. The method of claim 27 further comprising transferring the file to one or more to other storage elements.

36. A method processing one or more files using a security application, the method comprising:
connecting the client to server, the server being coupled to one or more storage elements;
transferring a file from a client to the server;
authenticating a user of the client;
authorizing the user for the file requested;
processing the file using a keyed message authentication integrity process;
generating header information for the file;
attaching the header information on the file; and
transferring the file to one or more of the storage elements.

37. The method of claim 36 further wherein the one or more storage elements comprises one or more NAS servers to one or more storage elements.

38. The method of claim 36 further comprising encrypting the file using a key size of at least 128 bits to form an encrypted file.

39. The method of claim 38 wherein the encrypting is provided using a NIST approved process.

40. The method of claim 38 wherein the encrypting is provided using AES-128, AES-192, AES-256 or Triple-DES.

41. The method of claim 36 wherein the keyed message authentication integrity process is provided by SHA-1, SHA-2, MD-5.

42. The method of claim 36 wherein the processing is provided at wirespeed, the wirespeed being greater than 1 Gigabit/second.

43. The method of claim 36 wherein the authenticating, authorizing, processing, generating, and attaching are provided at the proxy server.

44. The method of claim 36 wherein the header information comprises at least one element selected from a time stamp, Encrypted Data Encrypted Key, Encrypted Data Hash MAC key, and File attributes.

45. A method for providing secured storage of data, the method comprising:
providing a key encryption key;
storing the key encryption key on a system;
storing a message authentication code generating key on the system;
decrypting a file encryption key with the key encryption key;
decryption a file message authentication code generating key with the key encryption key;
using the file encryption key to decrypt data stored on a server or encrypt data originated by a user on a client;
generating a message authentication code for a header of the file with the message authentication code generating key; and
using the file message authentication code generating key to generate one or more message authentication codes block by block in the file.

46. The method of claim 45 wherein the file encryption key is provided in the file.

47. The method of claim 45 wherein the file message authentication key is provided in the file.

48. The method of claim 45 wherein the file message authentication key verifies content of data of the file upon a read process.
